(19) United States
(12) Patent Application Publication
(10) Pub. No.: US 2004/0172641 A1
(43) Pub. Date: Sep. 2, 2004

(54) Recording media drive device

(76) Inventor: Hitoshi Saito, Tokyo (JP)

Correspondence Address: RADER FISHMAN & GRAUER PLLC, LION BUILDING, 1233 20TH STREET N.W., SUITE 501, WASHINGTON, DC, 20036, US

(21) Appl. No.: 10/684,469

(22) Filed: Oct. 15, 2003

(30) Foreign Application Priority Data
Oct. 22, 2002 (JP) P2002-307461

(51) Int. Cl. G11B 33/02

(52) U.S. Cl. 720/646

(57) ABSTRACT

There is therefore a need to be able to change a front panel in a straightforward manner without requiring tools or spare parts. In order to fulfill this need, a recording medium drive device of the present invention includes a body; at least signal reading means, of signal writing means for writing signals to a recording medium and the signal reading means for reading signals provided within the body, and a front panel covering the front of the body and having an insertion/removal opening for inserting and removing the recording medium to and from the body. The front panel is supported in a freely detachable manner as a result of engagement with the body, and the engagement is achieved by moving the front panel towards the body, and a force to move the front panel away from the body acts in a direction releasing the engagement.

### CROSS REFERENCES TO RELATED APPLICATIONS

The present invention claims priority to its priority document No. 2002-307461 filed in the Japanese Patent Office on Oct. 22, 2002, the entire contents of which being incorporated by reference herein.

### BACKGROUND OF THE INVENTION

1. Field of the Invention

The present invention relates to a novel recording media drive apparatus, and particularly relates to technology enabling straightforward changing of a front panel that covers the front side of a body equipped with means for writing and/or reading a signal to/from a recording media and has an insertion/removal opening for inserting and removing the recording media.

2. Description of Related Art

Various recording media drive apparatuses such as flexible disc drive apparatuses, optical disc drive apparatuses, and magneto-optical disc drive apparatuses etc. are employed as external storage devices in information processing apparatus such as personal computers etc.

The overall dimensions etc. of these types of recording media drives are standardized to enable a user to exchange or expand such devices themselves. This also enables a so-called “build-it-yourself” approach where a user starts with a motherboard, then assembles a personal computer by selecting the desired built-in peripheral apparatus.

For example, a space, referred to as a “bay”, for housing built-in peripheral apparatus, is prepared at a body of a personal computer, with it then being possible to install desired peripheral apparatus at a desired bay. The fronts of bays that are to house removable recording media drive apparatuses are provided with openings to enable access from outside of the body and the openings are covered over by covers. When a new removable recording media drive apparatus is mounted, the cover is removed and the front of the recording media drive apparatus installed in the bay is made to face to outside of the body so that it is possible to insert/remove the recording media.

The recording media drive apparatus includes signal writing means for writing signals to the recording media within the body and/or signal reading means for reading signals. The front of the body is covered by a front panel having an insertion/removal opening for insertion and removal of the recording media into and out of the body. The front panel is therefore exposed at the front of the body of information processing apparatus such as a personal computer when a recording media drive apparatus is installed in a bay in the above manner.

In the case of expanding or exchanging the recording media drive apparatus at the information processing apparatus, the appearance of the information processing apparatus will deteriorate if the color or design of the front panel of the exchanged or expanded recording media drive apparatus does not match with the body of the information processing apparatus or with the color or design of existing peripheral apparatus.

It has therefore been considered to make the front panel freely detachable from the body (refer to patent document 1), and to prepare several front panels of different designs and colors to make it possible to select a front panel corresponding to a body of information processing apparatus which is to be installed to and to existing peripheral apparatus.

Patent Document 1

Japanese Patent Laid-open Publication No. 3-185899 (FIG. 1, FIG. 2, page 2).

### SUMMARY OF THE INVENTION

Here, one end of front panel (of option block (2)) shown in patent document 1 hooks into a body (refer to part A of FIG. 2) and the other end is fixed using a screw 3. Parts and tools (a screwdriver) other than the front panel and body are therefore necessary in order to fix the front panel. The front panel therefore cannot be changed in a straightforward manner.

There is therefore a need to be able to change a front panel in a straightforward manner without requiring tools or spare parts.

In order to resolve the aforementioned problems, in the recording media drive apparatus of the present invention, a front panel is supported in a freely detachable manner through engagement with a body housing signal writing means for writing signals to a recording media and/or signal reading means for reading signals from the recording media. The engagement is achieved by causing the front panel to move towards the body. Force causing the front panel to move in a direction away from the body acts in a direction causing release of the engagement.

Engagement of the front panel and the body is therefore achieved in the recording media drive apparatus of the present invention simply by moving the front panel towards the body. Engagement of the front panel and the body is then released simply by moving the front panel in a direction away from the body.

A recording media drive apparatus according to a first aspect of the present invention is characterized by including: a body; signal writing means for writing a signal to a recording media and/or signal reading means for reading a signal, provided within the body; and a front panel covering the front of the body and having an insertion/removal opening for inserting and removing the recording media to and from the body. The front panel is supported in a freely detachable manner as a result of engagement with the body. The engagement is achieved by moving the front panel towards the body, and a force to move the front panel in a direction away from the body acts in a direction releasing the engagement.

Accordingly, in the recording media drive apparatus according to the first aspect of the present invention, the engagement of the front panel and the body may be achieved by simply moving the front panel toward the body, and the engagement of the front panel and the body may be released by moving the front panel away from the body. It is therefore possible to attach and detach the front panel to and from the body in a straightforward manner without using tools and without using parts other than the front panel and the body and the front panel can therefore be changed as desired.

With a recording media drive apparatus according to the second aspect of the present invention, engagement is achieved by mutual engagement of engaging holes provided at one of the front panel and the body and engaging projections provided at the remaining one of the front panel and the body. Further, an inclined surface is formed at the engaging projection or at an edge of an opening of the engaging hole so as to cause the engaging projection or the engaging hole to move in a direction away from the engaging hole or the engaging projection as a result of applying force to cause the front panel to move in a direction away from the body. A structure for attaching and detaching a front panel to and from a body in a straightforward manner without using tools and without using parts other than the front panel and the body may therefore easily be constructed.

A recording media drive apparatus according to the third aspect of the present invention includes a slider and an eject button. The slider is provided within the body, and induces an eject motion for ejecting the recording media installed within the body from the insertion/removal opening as a result of pushing from the front. The eject button projects forwards from the front panel that is fitted in a freely detachable manner as a result of engagement with the slider. Engagement is achieved as a result of causing the eject button to move towards the slider, and force causing the eject button to move in a direction away from the slider acts in a direction releasing the engagement. Attaching and detaching of the eject button to and from the slider can therefore be achieved without using any tools and without requiring any parts other than the eject button and the slider and the eject button can be changed as desired.

With a recording media drive apparatus according to the fourth aspect of the present invention, engagement is achieved by mutual engagement of engaging holes provided at one of the eject button and the slider and engaging projections providing at the remaining one of the eject button and the slider. Further, an inclined surface is formed at the engaging projection or the engaging hole so as to cause the engaging projections or the engaging holes to move in a direction away from the engaging holes or the engaging projections as a result of applying force to cause the eject button to move in a direction away from the slider. It is therefore possible to construct a structure for attaching and detaching an eject button to and from a slider in a straightforward manner without having to use tools and without having to use parts other than the eject button and slider.

### BRIEF DESCRIPTION OF THE DRAWINGS

The above and other objects, features and advantages of the present invention will become more apparent from the following description of the presently preferred exemplary embodiment of the invention taken in conjunction with the accompanying drawing, in which:

FIG. 1 shows an embodiment of a recording media drive apparatus of the present invention and is a perspective view showing both a recording media drive apparatus and a recording media cartridge;

FIG. 2 is a perspective view showing essential parts of a state where engagement of one side part of a display panel with a body is released;

FIG. 3 is a perspective view showing essential parts with a front panel removed from a body;

FIG. 4 is an exploded perspective view showing essential parts of a mechanism for inserting and removing a recording media;

FIG. 5 is an enlarged cross-sectional view of essential parts showing a situation of attaching and detaching a frront panel to and from a body;

FIG. 6 is an enlarged cross-sectional view of essential parts showing a further example of a method for attaching and detaching a front panel to and from a body;

FIG. 7 is an enlarged cross-sectional view of essential parts showing a situation of attaching and detaching an eject button to and from a slider;

FIG. 8 is a plan view of essential parts showing a situation of attaching and detaching an eject button to and from a slider;

FIG. 9 is a cross-sectional view of essential parts for illustrating, together with FIG. 10 and FIG. 11, an operation from installation to ejection of a recording media cartridge to and from a recording media drive apparatus, and shows a situation where the recording media cartridge is midway through being inserted into the recording media drive apparatus;

FIG. 10 is a view showing a situation at the instant where the recording media cartridge is inserted to the back of the cartridge holder;

FIG. 11 is a view showing a situation where the recording media cartridge is installed in the recording media drive apparatus;

FIG. 12 is across-sectional view of essential parts showing a modified example of an engaging structure for a body and a front panel; and

FIG. 13 is across-sectional view of essential parts showing a modified example of an engaging structure for a slider and an eject button.

### DESCRIPTION OF THE PREFERRED EMBODIMENT

The following is a description with reference to the attached drawings of a preferred embodiment of a recording media drive apparatus of the present invention. The following shows a preferred embodiment of the present invention as applied to a flexible disc drive apparatus but the present invention may also be applied to, for example, various recording media drive apparatuses such as optical disc devices or magneto-optical disc drives, etc.

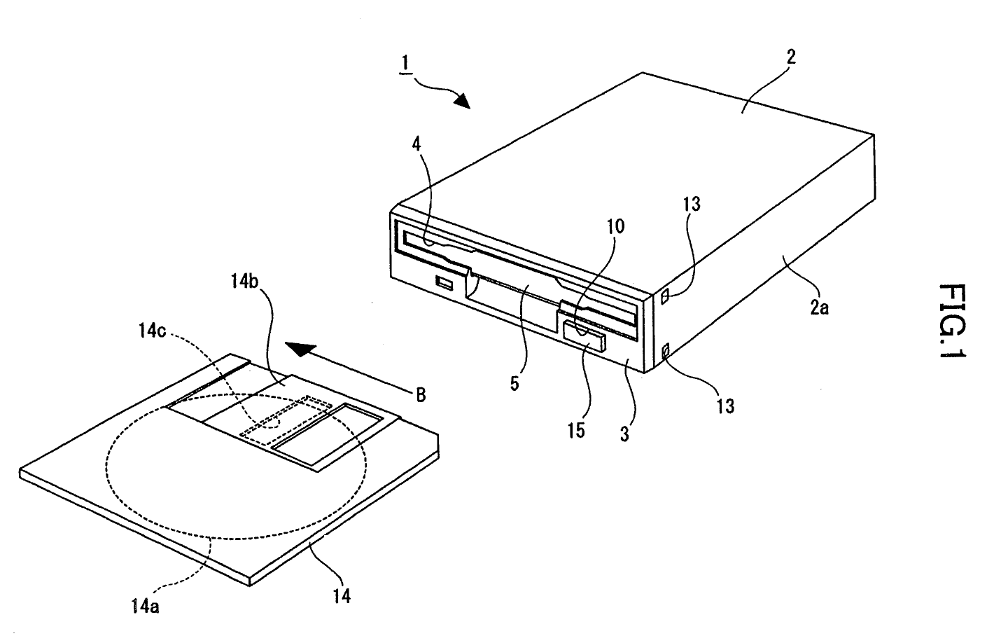

FIG. 1 shows the external appearance of a flexible disc drive apparatus 1 that is a recording media drive apparatus of this embodiment.

The flexible disc drive apparatus 1 includes a body 2 containing signal writing means and signal reading means (not shown) for writing and reading signals to and from a flexible disc. The front of the body 2 is covered with a front panel 3. Other types of recording media drive apparatuses may be equipped only with signal reading means and not with signal recording means. It should be noted that the expression “A and/or B” used in this specification is used to selectively indicate the concept of “A and B” or “A or B”.

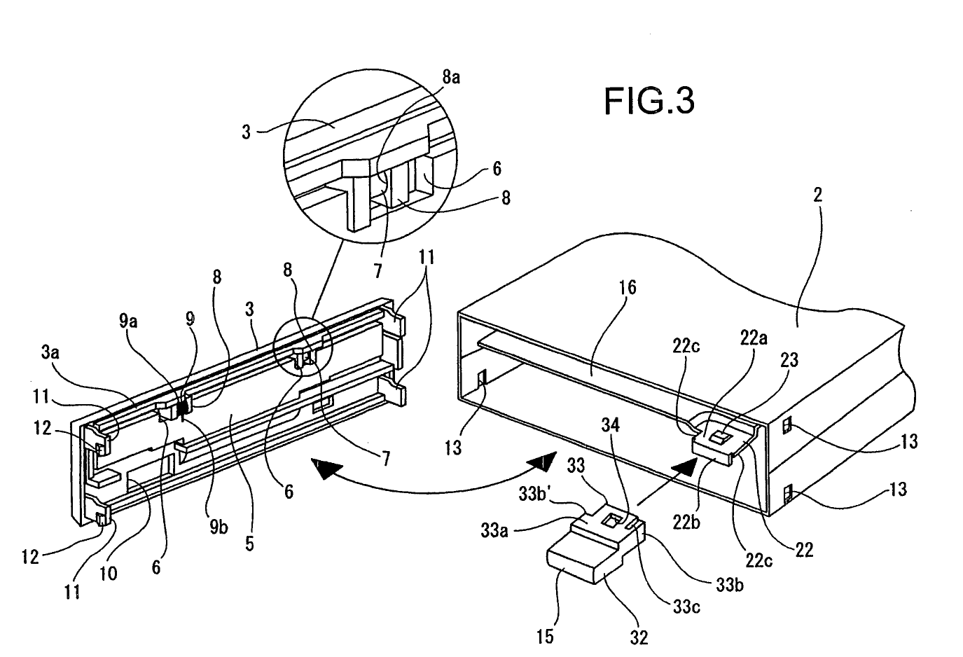

The front panel 3 has a rectangular shape elongated in lateral direction and is formed of synthetic resin. A laterally-elongated insertion/removal opening 4 is formed at the front panel 3 and a cover 5 is provided for opening and closing the insertion/removal opening 4. As can be understood from FIG. 3 and FIG. 9 to FIG. 11, the cover 5 is a plate shape that is larger than the insertion/removal opening 4. Two notches 6, 6 are formed at an upper edge of the cover 5 spaced to the left and right so as to sandwich a central part in a horizontal direction, with shafts 7, 7 being provided projecting from side edges at around the centers of the notches 6, 6. Two support brackets 8, 8 are provided spaced to the left and right at positions from the upper edge of the back of the front panel 3 and support holes 8a, 8a are formed in the support brackets 8, 8. The shafts 7, 7 of the cover 5 are passed through the support holes 8a, 8a so as to be rotatable and so as to ensure that the cover 5 is supported in a freely rotatable manner at the front panel 3. The cover 5 is urged in a closing direction by a torsion coil spring 9. A coiled part 9a of the torsion coil spring 9 fits around one of the shafts 7 of the cover 5 and one arm part 9b of the torsion coil spring 9 makes forcible contact with the back of the cover 5. A remaining arm part 9c of the torsion coil spring 9 makes forcible contact with a lower surface of an upper edge part 3a projecting slightly to the rear from the upper edge of the front panel 3. As a result, the cover 5 is urged in a closing direction so as to close the insertion/removal opening 4 of the front panel 3 from the back.

A laterally elongated rectangular button insertion hole 10 is formed below the portion where the insertion/removal opening 4 of the front panel 3 is formed.

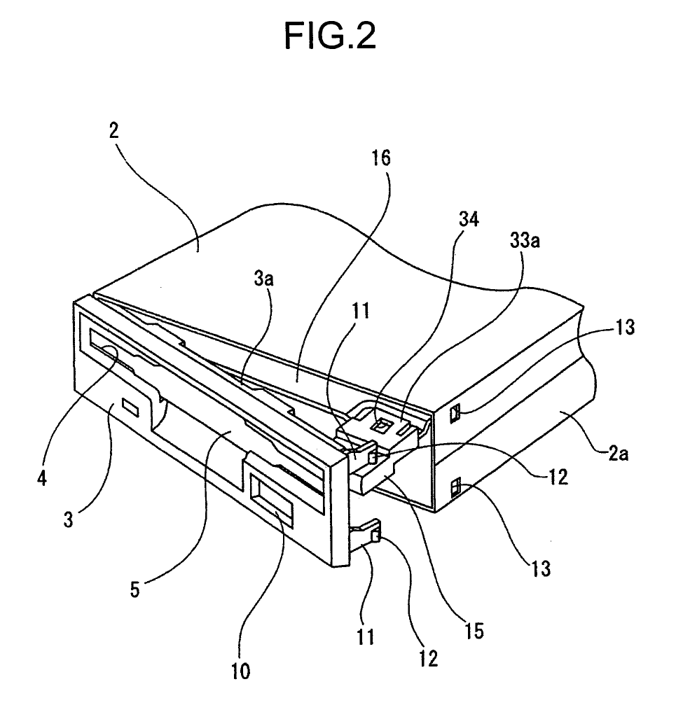

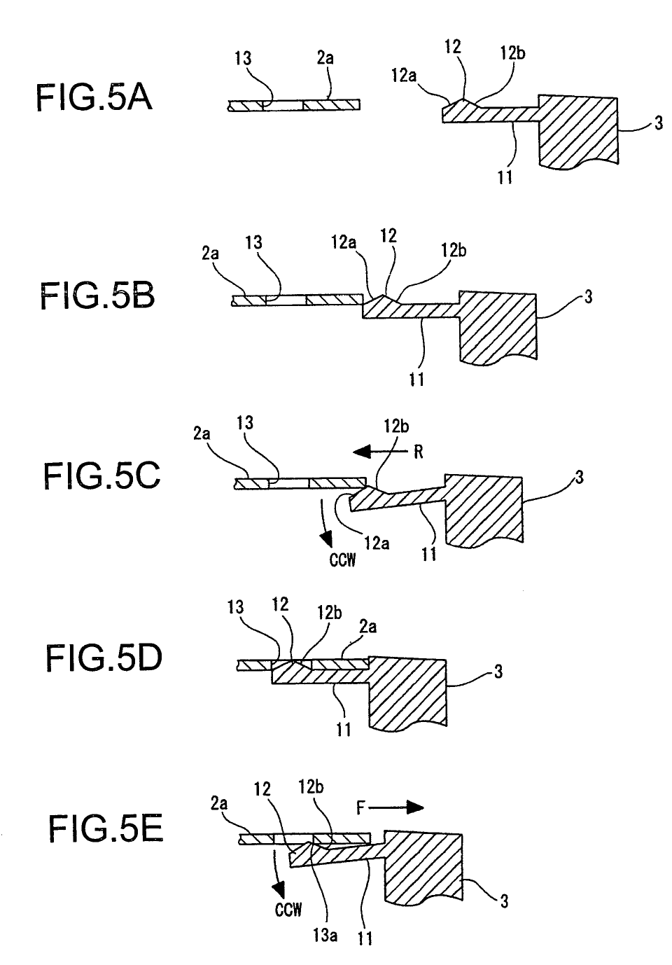

As can be understood from FIG. 2 and FIG. 3, two pairs of left and right engaging pieces 11, 11, . . . are provided to as to face to the rear from positions to upper and lower ends of both left and right side edges of the front panel 3, with engaging projections 12, 12, . . . being provided at outer surfaces of ends of the engaging pieces 11, 11 . . . . As is understood from FIG. 5, the engaging projections 12 are triangular in shape when viewed from above and have inclined surfaces 12a and 12b to the front and rear, respectively. Namely, the top-side inclined surface 12a is formed so as to become closer to the engaging piece 11 when going towards the end side at the end side of the engaging piece 11 and an base-side inclined surface 12b is formed on a base side, i.e. on the side near to the front panel 3, so as to become closer to the engaging piece 11 as the base is approached.

As can be understood from FIG. 1 to FIG. 3 and FIG. 5, engaging holes 13, 13, . . . are formed at positions to the upper and lower ends of front ends of side walls 2a, 2a of the body 2.

The front panel 3 is fitted to the body 2 so as to cover a front opening of the body 2 as a result of the engaging projections 12, 12, . . . of the engaging pieces 11, 11 . . . engaging with the engaging holes 13, 13, . . . of the body 2. A description is now given with reference to FIG. 5 of fitting the front panel 3 to the body 2.

First, the front panel 3 is brought close to the body 2 so that the height of the engaging pieces 11, 11, . . . of the front panel 3 becomes the same as the height of the engaging holes 13, 13, . . . of the body 2 (refer to FIG. 5(a)). The top-side inclined surfaces 12a, 12a, . . . at the sides of the ends of the engaging projections 12, 12, . . . provided at the ends of the engaging pieces 11, 11, . . . then come into contact with front ends of side walls 2a, 2a, . . . of the body 2 (refer to FIG. 5(b)). Only a side wall 2a for one side of the body 2, one engaging hole 13, and one engaging piece 11 are shown in FIG. 5.

When the front panel 3 moves to the side of the body 2 i.e. in the direction of an arrow R in FIG. 5(c) from the state shown in FIG. 5(b), the top-side inclined surface 12a at the end side slides smoothly along the front end of the side wall 2a. The end of the engaging piece 11 is therefore subjected to force in a direction shown by an arrow CCW in FIG. 5(c), causing the engaging piece 11 to flex (refer to FIG. 5(c)). As a result of the flexing of the engaging piece 11 in the direction CCW of the arrow in FIG. 5(c), the engaging projection 12 slides smoothly along the inner surface of the side wall 2a of the body 2 so that the front panel 3 moves in the direction of the arrow R in FIG. 5(c).

When the engaging projection 12 reaches the position of the engaging hole 13, the engaging piece 11 that was flexed in the direction of the arrow CCW in FIG. 5(c) returns to its original state. The engaging projection 12 then engages with the engaging hole 13 so as to fit the front panel 3 to the body 2 in such a manner as to cover the front of the body 2.

The front panel 3 is fitted to the body 2 so as to cover the front of the body 2 as a result of the engaging projections 12, 12, . . . of the front panel 3 engaging with the engaging holes 13, 13, . . . of the body 2.

When removing the front panel 3 from the body 2, when a force is fairly firmly applied so as to move the front panel 3 forwards, i.e. in the direction of arrow F in FIG. 5(e), the base-side inclined surface 12b on the base side of the engaging projection 12 slides smoothly along a front side edge 13a of the engaging hole 13. The end of the engaging piece 11 is therefore subjected to force so as to move in the direction of arrow CCW in FIG. 5(e) so as to flex (refer to FIG. 5(e)).

Engagement of the engaging projection 12 with the engaging hole 13 is therefore released as a result of the flexing of the end of the engaging piece 11 in the direction of the arrow CCW in FIG. 5(e). As a result, the engaging projection 12 can slide smoothly along the inside surface of the side wall 2a of the body 2 in the direction of the arrow F and the front panel 3 can be removed from the body 2.

The front panel 3 can be attached to and detached from the body 2 using a different method to the method shown in FIG. 5.

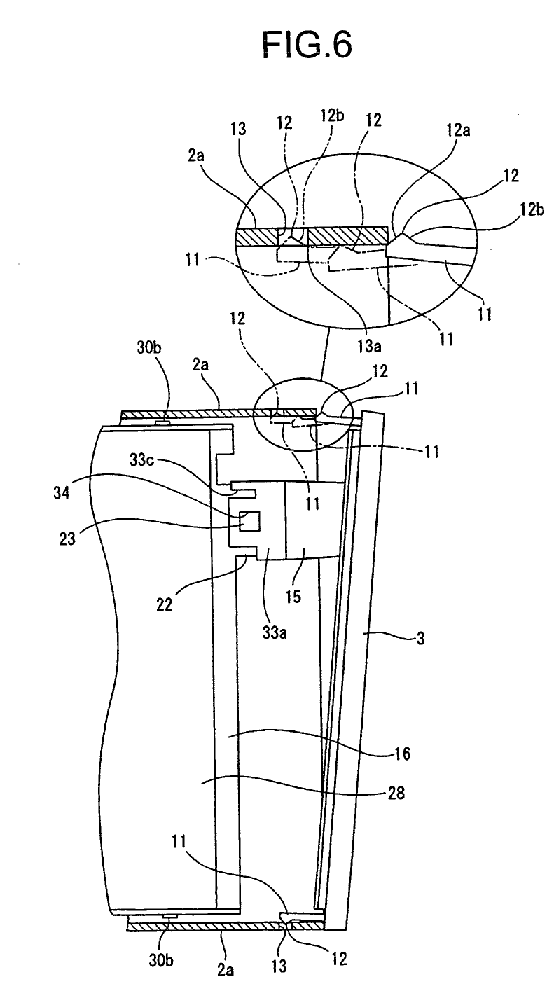

When the front panel 3 is fitted to the body 2, first, engaging projections 12, 12 of the engaging pieces 11, 11 formed on one side of the front panel 3 are made to engage in advance with engaging holes 13, 13 formed in a side wall 2a on one side of the body 2. The top-side inclined surfaces 12a, 12a on the end side of the engaging projections 12, 12 of the engaging pieces 11, 11 formed on the other side of the front panel then make contact with the front end of the side wall 2a on the other side of the body 2 (refer to the solid lines in FIG. 6).

The side of the other side of the front panel 3 is then pushed in from the state shown by the solid line in FIG. 6 (refer to arrow R in FIG. 6). The top-side inclined surfaces 12a, 12a at the ends of the engaging projections 12, 12 at the other side then slide smoothly at the front end of the side wall 2a of the body 2, the portions on which the engaging projections 12, 12 are formed are subjected to force causing movement in the direction of arrow CCW, and the engaging pieces 11, 11 are flexed. The engaging projections 12, 12 then move smoothly to the rear along the inner surface of the side wall 2a (refer to the single-dotted-and-dashed line of FIG. 6).

When the engaging projections 12, 12 for the other side reach the positions of the engaging holes 13, 13 of the other side, the engaging projections 12, 12 engage with the engaging holes 13, 13 and the front panel 3 is fitted to the body 2 (refer to the double-dotted-and-dashed line of FIG. 6).

When the front panel 3 is removed from the body, force is exerted so that the other side of the front panel 3 is dragged out from the body, i.e. force is exerted in the direction of arrow F in FIG. 6. The base-side inclined surfaces 12b, 12b on the base side of the engaging projections 12, 12 on the other side therefore move smoothly at side edges 13a, 13a of the engaging holes 13, 13, the engaging pieces 11, 11 flex in the direction of the arrow CCW, and the engaging pieces 11, 11 come away from the body 2 via the state shown by the single-dotted-and-dashed line. It is therefore possible to remove the front panel 3 from the body 2.

The front panel 3 can easily be fitted to the body 2 simply by lining up the front panel 3 and pushing the front panel 3 towards the body 2. Further, the front panel 3 can also be easily detached from the body 2 simply by applying force so as to pull the front panel 3 away from the body 2. There is also no requirement for any kind of parts other than the front panel 3 and the body 2 to attach and detach the body 2 to and from the front panel 3.

A change can therefore easily be made to a desired front panel by preparing various types of front panel 3 that match with the body 2.

At the flexible disc drive apparatus 1, a flexible disc cartridge 14 (refer to FIG. 1, hereinafter referred to as “cartridge”) housing a flexible disc 14a, that is a disc-shaped magnetic disc, in a rotatable manner is installed in the body 2 via the insertion/removal opening 4 of the front panel 3 so that writing and reading of signals to and from the flexible disc 14a installed within the cartridge 14 can be carried out. When writing and/or reading of signals to and from the flexible disc 14a is complete, the cartridge 14 is ejected from within the body 2. The flexible disc drive apparatus 1 includes a slider 16 to induce the eject motion and an eject button 15 to push the slider.

As can be understood from FIG. 1 and FIG. 9 to FIG. 11, the eject button 15 is inserted through the button insertion hole 10 formed in the front panel 3 so that a front end of the eject button 15 projects towards the front from the front panel 3. The slider 16 is provided within the body 2 in order to control installation and ejection of the cartridge 14. The eject button 15 is fitted to the front end of the slider 16 and moves together with the slider.

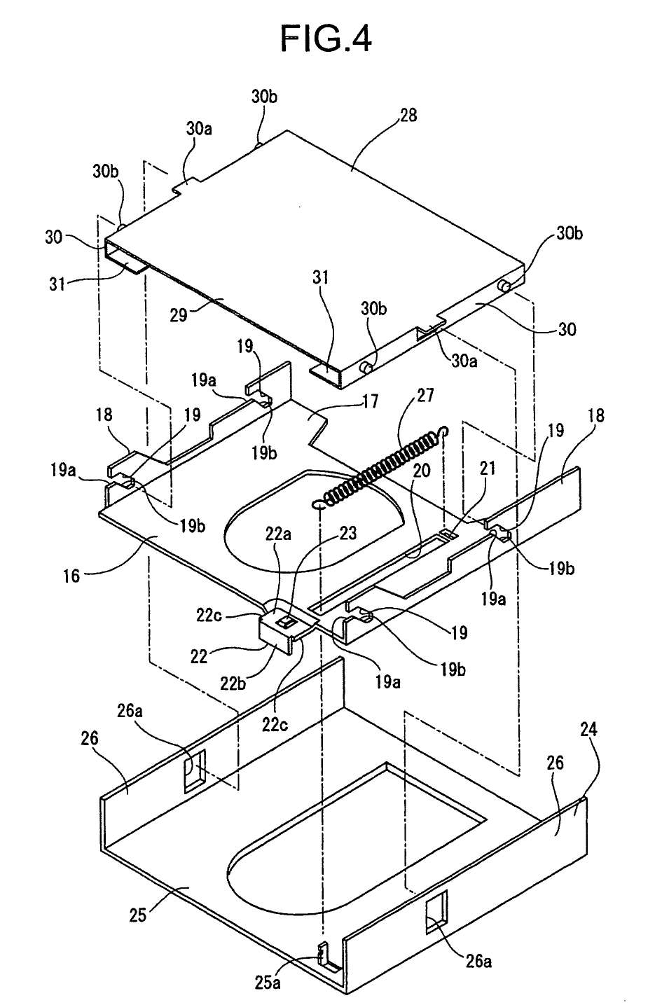

As can be understood from FIG. 4, the slider 16 is integrally formed from a bottom plate 17 and side plates 18, 18 projecting upwards from the left and right side edges of the bottom plate 17. Two slits 19, 19, . . . are formed to the front and rear of both the left and right side plates 18, 18. Each slit 19 has a horizontal part 19a positioned to the upper end of each side plate 18 and extending horizontally, and an inclined part 19b extending downwards from the rear end of the horizontal part 19a. A positioning slit 20 is formed positioned close to one side of the bottom plate 17 extending in a direction from front to back and a spring peg 21 is formed next to the rear end of the positioning slit 20.

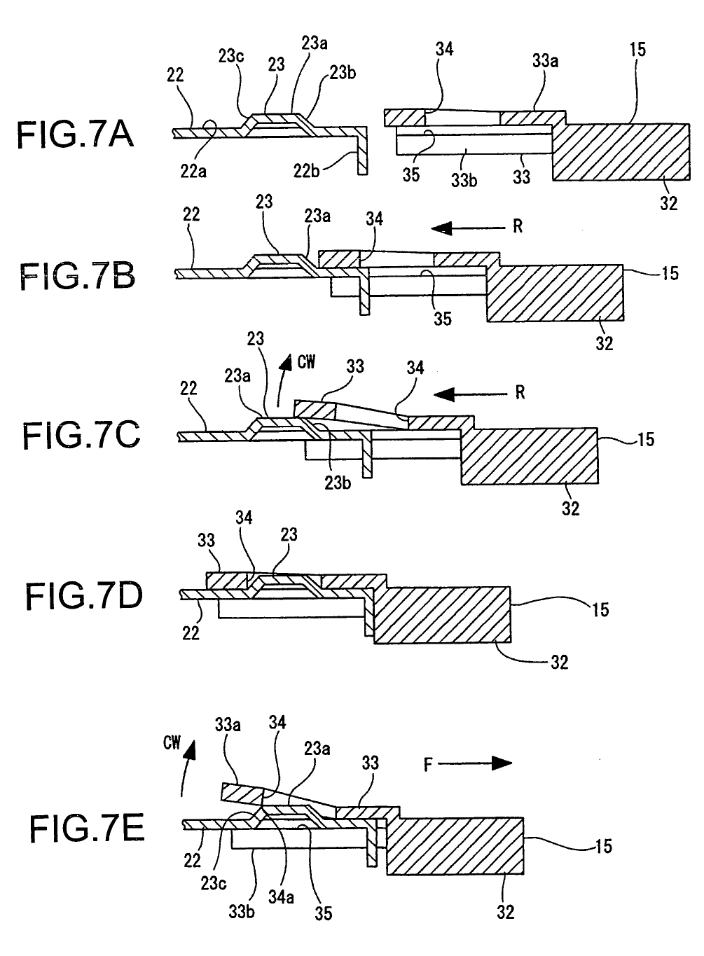

As can be understood from FIG. 7, a button support piece 22 is provided facing towards the front at a position by one side part of a front edge of the bottom plate of the slider 16. A front piece is formed projecting downwards from the front end of a main piece 22a extending towards the front of the button support piece 22. The width of the front piece 22b is slightly less than the width of the main piece 22a so as to form engaging edges 22c, 22c at both side edges of the main piece 22a. An engaging projection 23 is formed so as to project upwards at a substantially central part of the main piece 22a. The engaging projection 23 is a trapezoidal shape as viewed from the side and has a central horizontal part 23a, a front-side inclined surface 23b extending downwards from the end of the horizontal part 23a, and a rear-side inclined surface 23c extending downwards to the rear from the rear end of the horizontal part 23a.

As can be understood from FIG. 4, a chassis 24 is fixed within the body 2 and the slider 16 is supported at the chassis 24 in such a manner as to be capable of movement in a direction from front to back. The chassis 24 includes a bottom part 25 and side parts 26, 26 projecting upwards from side edges of the bottom part 25. A spring peg 25a is formed projecting upwards at a position to the front end of the bottom part 25, and guide slits 26a, 26a extending vertically are formed at a substantially central part in a direction from the front to the rear of the side parts 26, 26.

The slider 16 is supported at the chassis 24 by means (not shown) in such a manner as to be freely moveable in a direction from front to back. A tensioning coil spring 27 is installed across the spring peg 21 of the slider 16 and the spring peg 25a of the chassis 24. This ensures that the chassis 24 is urged towards the front, i.e. in the direction of arrow F in FIG. 4. The tensioning coil spring 27 is arranged within the positioning slit 20 formed at the bottom plate 17 of the slider 16.

As can be understood from FIG. 4 and FIG. 9 to FIG. 11, a cartridge holder 28 supporting the cartridge 14 and moving up and down is supported at the chassis 24 in a manner enabling up and down movement. The cartridge holder 28 is integrally formed from a top plate 29, side plates 30, 30 projecting downwards from both side edges of the top plate 29, and buttresses 31, 31 projecting in directions towards each other from lower edges of the side plates 30, 30. Guide pieces 30a, 30a project to the sides from upper ends of central parts of the side plates 30, 30 in a direction from front to back. Guide pins 30b, 30b project to the sides at positions to each end to both the front and rear of the side plates 30. The guide pieces 30a, 30a of the cartridge holder 28 engage with the guide slits 26a, 26a of the chassis 24 in a freely slideable manner. This enables the cartridge holder 28 to move in only a vertical direction. The guide pins 30b, 30b . . . of the cartridge holder 28 engage with the slits 19, 19, . . . of the slider 16 in a freely slideable manner. This means that the cartridge holder 28 moves in an up and down direction as the slider 16 moves in a direction to the front and rear.

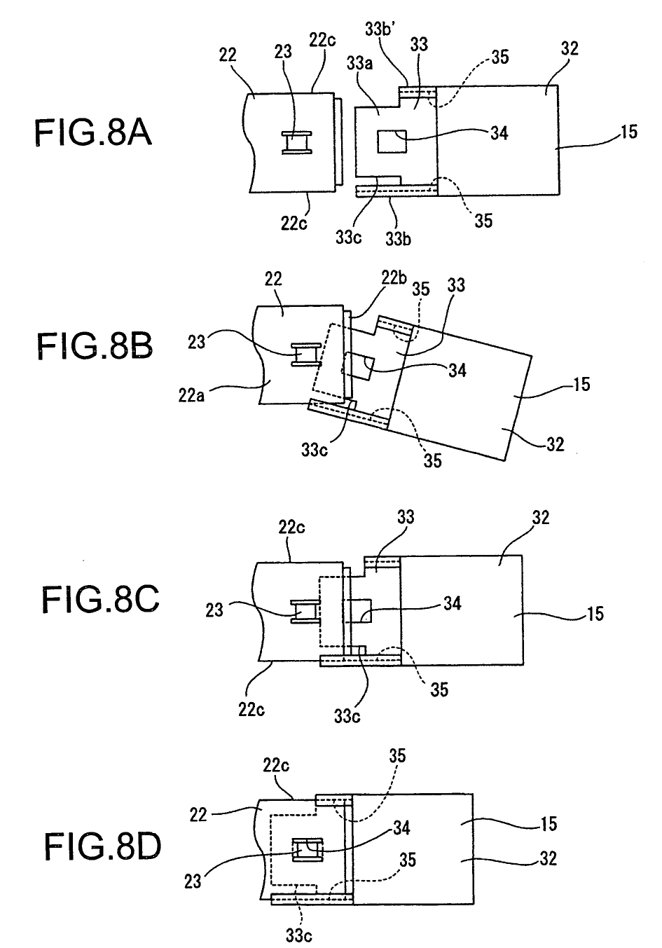

As can be understood from FIG. 3, FIG. 7 and FIG. 8, the eject button 15 is formed from synthetic resin and is integrally formed from a button part 32 and a coupling part 33 projecting to the rear from the rear end of the button part 32. The button part 32 is a block-shape of a size capable of being passed through the button insertion hole 10 of the front panel 3. The coupling part 33 includes an upper surface part 33a, and side surface parts 33b, 33b′ projecting downwards from left and right side parts of the upper surface part 33a. An engaging hole 34 is formed at a substantially central part of the upper surface part 33a, and engaging grooves 35, 35 extending in a direction from front to back and reaching a rear end are formed at mutually facing surfaces of the side surface parts 33b, 33b′. The side surface part 33b of the side surface parts 33b, 33b′ is formed to be substantially half the length of the upper surface part 33a. However, the remaining side surface part 33b is formed up to close to the end of the upper surface part 33a. A slit 33c is formed between the other side surface part 33b and the upper surface part 33a to give the upper surface part 33a flexibility.

The eject button 15 is fitted to the slider 16 in the following manner.

First, the position of the eject button 15 is lined up with respect to the button support piece 22 of the slider 16 in such a manner that the heights of the engaging grooves 35, 35 of the eject button 15 are the same as the heights of engaging edges 22c, 22c of the button support piece 22 of the slider 16 (refer to FIG. 7(a), FIG. 8(a)).

When the eject button 15 is moved towards the slider 16, i.e. in a direction shown by arrow R in FIG. 7(b) from a state where the position of the eject button 15 is aligned with respect to the button support piece 22, engaging edges 22c, 22c of the button support piece 22 engage with the engaging grooves 35, 35 of the eject button 15 (refer to FIG. 7(b), FIG. 8(c)). As shown in FIG. 8(b), when the eject button 15 does not face the button support piece 22, the engaging edges 22c, 22c of the button support piece 22 do not engage with the engaging grooves 35, 35 of the eject button 15.

When the eject button 15 is made to move in the direction shown by the arrow R in FIG. 7(c) from the state shown in FIG. 7(b) and FIG. 8(c), the end of the upper surface part 33a of the eject button 15 makes contact with the front-side inclined surface 23b of the engaging projection 23 of the button support piece 22. The front-side inclined surface 23b therefore moves smoothly and the end of the upper surface part 33a is flexed so as to move in the direction of the arrow CW in FIG. 7(c). An end portion coming from the engaging hole 34 of the upper surface part 33a then rides up onto the horizontal part 23a of the engaging projection 23 (refer to FIG. 7(c)).

When the eject button 15 is moved further in the direction of the arrow R, the engaging projection 23 provided at the button support piece 22 of the slider 16 engages completely with the engaging hole 34 of the eject button 15 (refer to FIG. 7(d), FIG. 8(d)) so that the eject button 15 is fitted to the slider 16.

When removing the eject button 15 from the slider 16, when a fairly strong force is applied in order to move the eject button 15 towards the front, i.e. in the direction of the arrow F in FIG. 7(e), an end side edge 34a of the engaging hole 34 slides smoothly over the rear-side inclined surface 23c of the engaging projection 23. The end of the upper surface part 33a of the coupling part 33 of the eject button 15 is therefore subjected to force so as to move in the direction of arrow CW in FIG. 7(e) so as to flex (refer to FIG. 7(e)).

Engagement of the engaging hole 34 with the engaging projection 23 is therefore released as a result of the flexing of the end of the upper surface part 33a in the direction of the arrow CW in FIG. 7(e). The eject button 15 can therefore move in the direction of the arrow F and can be removed from the slider 16 as a result.

The eject button 15 can therefore be detached from the slider 16 in a straightforward manner simply by moving the eject button 15 in a prescribed direction. This does not require any special tools or the use of parts other than the eject button 15 and the slider 16.

A change can therefore easily be made to a desired eject button 15 by preparing various types of eject buttons 15 that match with the body 2 and the front panel 3.

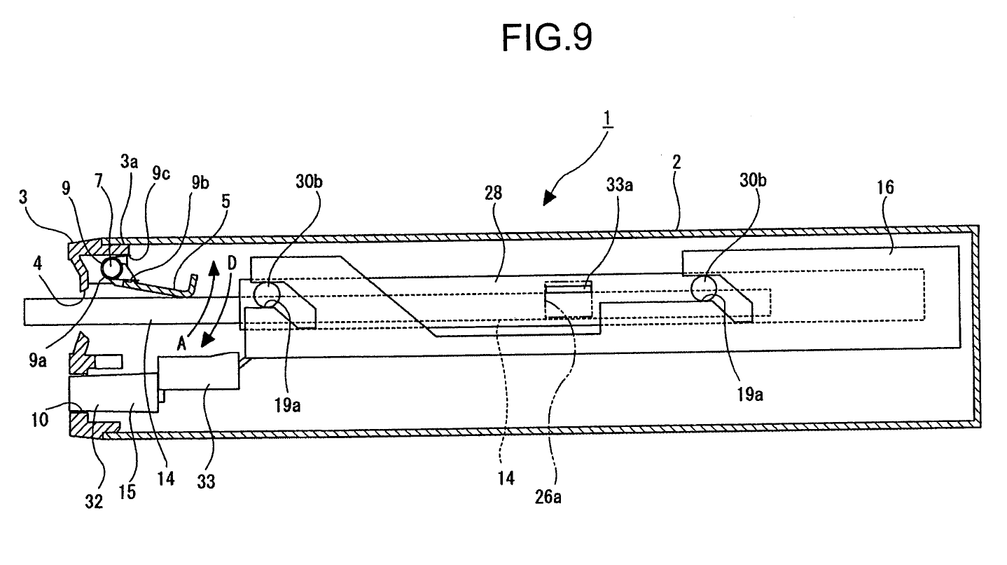

Next, a brief description is given with reference to FIG. 9 to FIG. 11 of installation and ejection of the cartridge 14.

As shown in FIG. 1, when the cartridge 14 is lined up with the insertion/removal opening 4 of the flexible disc drive apparatus 1 and is inserted into the insertion/removal opening 4, the cover 5 covering the insertion/removal opening 4 is pushed to the rear by the end of the cartridge 14. This causes the cover 5 to move to the rear against the resistance of urging force of the torsion coil spring 9, i.e. the cover 5 turns in the direction of arrow A in FIG. 9, and the insertion/removal opening 4 is opened. The cartridge 14 is then inserted to within the cartridge holder 28, i.e. into a space surrounded by the top plate 29, side plates 30, 30, and buttresses 31, 31 (refer to FIG. 9). When the cartridge 14 is not installed, the slider 16 is positioned at the rear end of its range of movement, and the guide pins 30b, 30b, . . . of the cartridge holder 28 are positioned at the horizontal parts 19a, 19a, . . . of the slits 19, 19, . . . of the slider 16. The cartridge holder 28 is therefore positioned at the upper end of its range of movement and is positioned at the same height as the insertion/removal opening 4. The slider 16 is locked by lock means (not shown) at the rear end of the range of movement of the slider 16.

As the cartridge 14 moves towards the end of the cartridge holder 28, a shutter 14b of the cartridge 14 moves in an opening direction, i.e. in the direction of arrow B in FIG. 1, so as to open upper and lower head access windows 14c, 14c (only the upper head access window 14c is shown in FIG. 1). As a result of this, a magnetic head (not shown) constituting signal reading means and signal writing means can come into contact with or come close to the flexible disc 14a and can read and write signals to and from the flexible disc 14a.

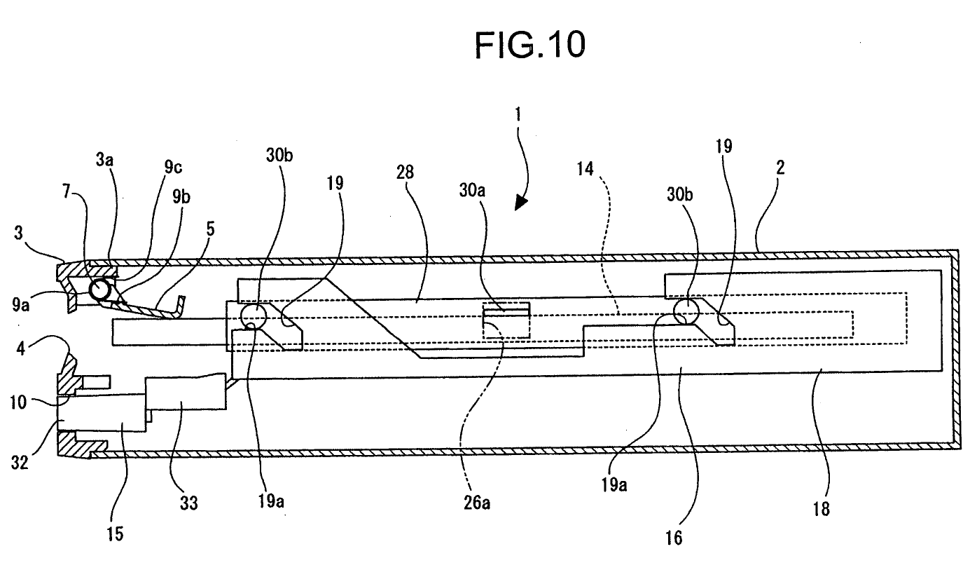

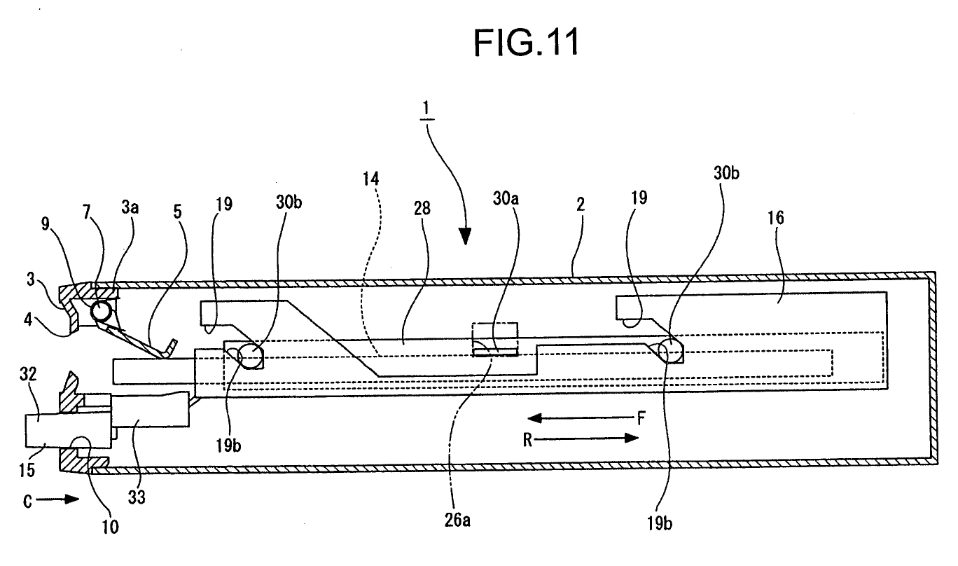

When the cartridge 14 is then inserted as far as the back of the cartridge holder 28 (refer to FIG. 10), the lock at the rear end of the range of movement of the slider 16 is released. The slider 16 then immediately moves in the direction of arrow F in FIG. 10 to the front end of the range of movement due to the urging force of the tensioning coil spring 27 (refer to FIG. 11). While the slider 16 is moving from the rear end of the range of movement to the front end, the guide pins 30b, 30b . . . of the cartridge holder 28 move from the upper ends of the inclined parts 19b, 19b, . . . of the slits 19, 19, . . . of the slider 16 to the lower ends. The cartridge holder 28 therefore moves to the lower end of its range of movement and the flexible disc 14a within the cartridge 14 supported at the cartridge holder 28 is installed in a disc rotating mechanism (not shown) and rotated by the disc rotating mechanism. As a result of movement of the slider 16 to the front end of the range of movement, the extent to which the eject button 15 fitted to the slider 16 projects outwards from the front panel 3 becomes large (compare the situations in FIG. 9 and FIG. 11). When the cartridge 14 is inserted to as far as the back of the cartridge holder 28, ejection force at an eject mechanism (not shown) for ejecting the cartridge 14 to the front from the cartridge holder 28 is stored up. At this time, the lower end of the cover 5 forcibly makes contact with the upper surface of the cartridge 14.

As a result of performing the above, installation of the cartridge 14 to the flexible disc drive apparatus 1, i.e. loading of the flexible disc 14a constituting a recording media is complete, and a state is attained where writing and reading of signals to and from the flexible disc 14a is possible.

When reading and/or writing of signals to and from the flexible disc 14a is complete and the cartridge 14 is to be extracted, the eject button 15 projecting from the front of the front panel 3 is pushed in, i.e. made to move in a direction shown by arrow C in FIG. 11.

The slider 16 moves to the rear as a result of pushing in the eject button 15, i.e. moves in the direction of arrow R in FIG. 11. As the slider 16 moves towards the rear, the positions where the guide pins 30b, 30b, . . . of the cartridge holder 28 engage with the slits 19, 19, . . . of the slider 16 move from the lower ends of the inclined parts 19b, 19b, . . . to the upper ends so as to move the cartridge holder 28 upwards.

When the eject button 15 is pushed in until the slider 16 reaches the rear end of the range of movement, the slider 16 is locked at the rear end of the range of movement, the cartridge holder 28 reaches the upper end of the range of movement, and force stored up by the eject mechanism (not shown) is released. As a result, the cartridge 14 is moved from the cartridge holder 28 in the direction of ejection and part of the cartridge 14 projects outwards from the insertion/removal opening 4 of the front panel 3. When the cartridge 14 moves in the ejection direction, the shutter 14b is made to return to a closed position, i.e. is made to return to the state shown in FIG. 1.

The cartridge 14 can then be removed from the flexible disc drive apparatus 1 by grasping and pulling out the portion of the cartridge 14 projecting from the insertion/removal opening 4. When the cartridge 14 is removed from the flexible disc drive apparatus 1, the cover 5 turns in a direction shown by arrow D in FIG. 9 due to urging force of the torsion coil spring 9 so as to close the insertion/removal opening 4.

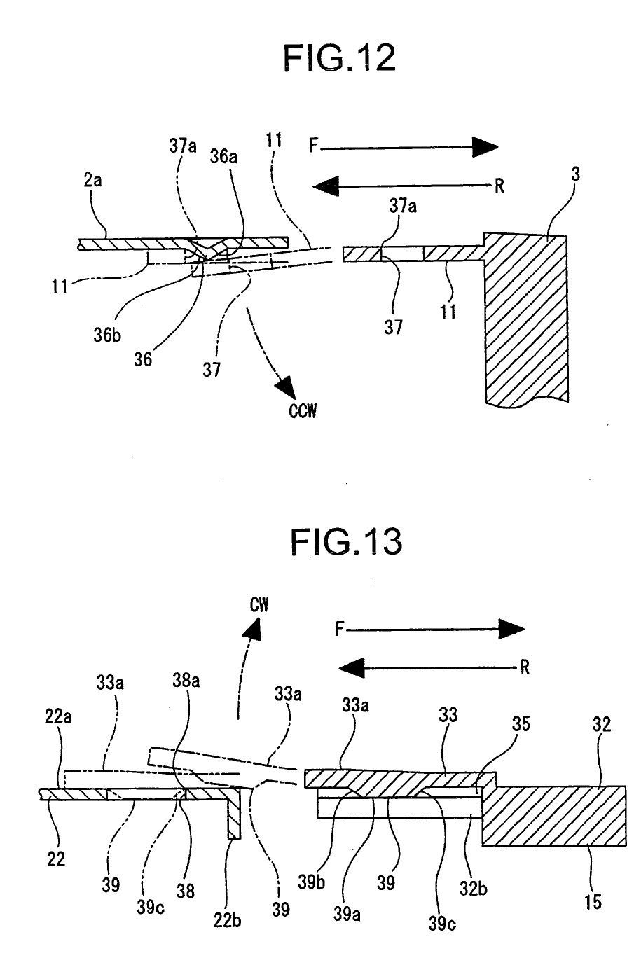

With the above flexible disc drive apparatus 1, engaging projections 12, 12, . . . are provided at the front panel 3 in order to fit the front panel 3 to the body 2. The font panel 3 is then fitted to the body 2 as a result of the engaging projections 12, 12, . . . engaging with engaging holes 13, 13, . . . provided at the body 2. However, the same results can also be demonstrated if engaging holes are formed in the front panel 3 and engaging projections are formed at the body 2. In the modified example shown in FIG. 12, engaging projections 36, 36, . . . are formed at side walls 2a of the body 2 and engaging holes 37, 37, . . . are formed at engaging pieces 11, 11, . . . of the front panel 3.

In this modified example, when the front panel 3 moves in the direction of the arrow R, the engaging piece 11 slides smoothly over the inner surface of the side wall 2a of the body 2. The end of the engaging piece 11 then comes into contact with a front end-side inclined surface 36a of engaging projection 36 and slides smoothly over. The engaging piece 11 then flexes in the direction of arrow CCW (refer to the single-dotted-and-dashed line of FIG. 12) and engaging hole 37 soon engages with engaging projection 36.

When force is applied to move the front panel 3 in the direction of arrow F when the front panel 3 is removed from the body 2, an end side edge 37a of engaging hole 37 slides smoothly along a rear end-side inclined surface 36b of the engaging projection 36. The engaging piece 11 is therefore flexed in the direction of arrow CCW and this releases engagement of the engaging hole 37 and engaging projection 36 so that the front panel 3 can be moved in the direction of arrow F. It is then possible to remove the front panel 3 from the body 2.

It is therefore possible in this modified example to attach and detach the front panel 3 to and from the body 2 without requiring any tools and without requiring any parts other than the front panel 3 and the body 2.

Further, an engaging projection 23 is formed at the slider 16 and an engaging hole 34 is formed at the eject button 15 in order to fit the eject button 15 to the slider 16 at the flexible disc drive apparatus 1 but it is also possible to form an engaging hole at the slider 16 and form an engaging projection at the eject button 15.

FIG. 13 shows a modified example configured in this manner, where an engaging hole 38 is formed in the button support piece 22 of the slider 16 and an engaging projection 39 is formed in the coupling part 33 of the eject button 15. The engaging projection 39 is formed as a trapezoidal shape when viewed from the side and is comprised of a horizontal part 39a, a top-side inclined surface 39b, and abase-side inclined surface 39c.

When the eject button 15 is lined up with the button support piece of the slider 16 and is moved in the direction of the arrow R, the top-side inclined surface 39b of the engaging projection 39 comes into contact with the front end of the main piece 22a of the button support piece 22 and slides smoothly over the end. The upper surface part 33a of the coupling part 33 of the eject button 15 is then flexed in the direction of arrow CW and the engaging projection 39 slides smoothly over the upper surface of the main piece 22a (refer to the single-dotted-and-dashed line of FIG. 13).

When the engaging projection 39 comes as far as the engaging hole 38, the engaging projection 39 and the engaging hole 38 engage with each other so that the eject button 15 is supported at the slider 16 (refer to the double-dotted-and-dashed line of FIG. 13).

When the eject button 15 is removed from the slider 16, the eject button 15 is held and force is applied in the direction of the arrow F. The base-side inclined surface 39c of the engaging projection 39 therefore slides smoothly over the front side edge 38a of the engaging hole 38. The upper surface part 33a of the coupling part 33 of the eject button 15 then flexes in the direction of arrow CW, the engagement of the engaging projection 39 and the engaging hole 38 is released, and the eject button 15 can be moved in the direction of arrow F. As a result of this, the eject button 15 can be removed from the slider 16.

It is also straightforward to attach and detach the eject button 15 and the slider 16 in this modified example without requiring any tools and without requiring any parts other than the eject button 15 and the slider 16.

The form and structure of each of the parts shown in the above embodiment and modified examples are given merely as examples for embodying the present invention and should by no means be interpreted as limiting the technological scope of the present invention.

What is claimed is:

1. A recording media drive apparatus comprising:
a body;
signal writing means for writing a signal to a recording media and/or signal reading means for reading a signal from the recording media, provided within said body; and
a front panel, covering the front of said body and having an insertion/removal opening for inserting and removing said recording media to and from said body, wherein
said front panel is supported in a detachable manner as a result of engagement with said body, and
said engagement is achieved by moving said front panel towards said body, and a force to move said front panel in a direction away from said body acts in a direction releasing said engagement.

2. The recording media drive as disclosed in claim 1, wherein
said engagement is achieved by mutual engagement of an engaging hole provided at one of said front panel and said body and an engaging projection provided at the remaining one of said front panel and said body, and
an inclined surface is formed at said engaging projection or at an edge of an opening of said engaging hole so as to cause said engaging projection or said engaging hole to move in a direction away from said engaging hole or said engaging projection as a result of applying force to cause said front panel to move in a direction away from said body.

3. The recording media drive apparatus as disclosed in claim 1, further comprising:
a slider, provided within said body, for inducing an eject motion for ejecting said recording media installed within said body from said insertion/removal opening as a result of pushing from the front, and
an eject button projecting forwards from said front panel fitted in a detachable manner as a result of engagement with said slider,
wherein said engagement is achieved as a result of causing said eject button to move towards said slider, and a force causing said eject button to move in a direction away from said slider acts in a direction releasing said engagement.

4. The recording media drive apparatus as disclosed in claim 3, wherein
said engagement is achieved by mutual engagement of an engaging hole provided at one of said eject button and said slider and an engaging projection providing at the remaining one of said eject button and said slider, and
an inclined surface is formed at said engaging projection or an edge of an opening of said engaging hole so as to cause said engaging projection or said engaging hole to move in a direction away from said engaging hole or said engaging projection as a result of applying force to cause said eject button to move in a direction away from said slider.
